(19) United States
(12) Patent Application Publication
(10) Pub. No.: US 2023/0222128 A1
(43) Pub. Date: Jul. 13, 2023

(54) METHOD AND SERVER FOR CREATING A TABLE AND DB I/O OBJECTS IN RDB MIGRATION PROCESS

(71) Applicant: TMAXSOFT CO., LTD., Gyeonggi-do (KR)

(72) Inventors: Dong Hyeon KIM, Gyeonggi-do (KR); Min Hyeok LEE, Gyeonggi-do (KR); Wonjun JEONG, Gyeonggi-do (KR); Hyolim SHIN, Gyeonggi-do (KR)

(73) Assignee: TMAXSOFT CO., LTD., Gyeonggi-do (KR)

(21) Appl. No.: 18/086,571

(22) Filed: Dec. 21, 2022

(30) Foreign Application Priority Data
Jan. 12, 2022 (KR) 10-2022-0004563

(51) Int. Cl. G06F 16/2457; G06F 16/22; G06F 16/242

(52) U.S. Cl. CPC G06F 16/24573; G06F 16/2282; G06F 16/2423

(57) ABSTRACT

Disclosed is a method for creating a table and DB I/O objects in a relational database (RDB) migration process performed by a server. The method may include: creating metadata through a static analysis for a job control language (JCL) statement and an execution program (PGM), the metadata including job information, field information, and dataset information; identifying a plurality of layouts based on the dataset information; creating a first table corresponding to a first layout among the plurality of layouts; and creating a CRUD query corresponding to a second layout among the plurality of layouts based on the first table.

### CROSS-REFERENCE TO RELATED APPLICATIONS

This application claims priority to and the benefit of Korean Patent Application No. 10-2022-0004563 filed in the Korean Intellectual Property Office on Jan. 12, 2022, the entire contents of which are incorporated herein by reference.

### TECHNICAL FIELD

The present disclosure related to a DBMS, and more particularly, to a method and a server for creating a table and DB I/O objects in a RDB migration process.

### BACKGROUND ART

Mainframe systems were introduced in the 1960s to 1970s by governments, financial institutions and large corporations to handle various data needed for business activities. The mainframe system means a large computer for a general purpose of performing various jobs by adopting a centralized method that connects multiple terminals to one computer. For example, System/360 of the IBM corresponds to the mainframe system. The mainframe system has continued to grow by leading the company's computing industry for nearly 30 years.

By referring Data Description (DD) definition of job control language, and an execution program (PGM) name, and a file description (FD) of an execution program, it may be identified which dataset a program such as COBOL of the job accesses in a mainframe environment.

In general, the COBOL program uses a data access object (DAO) having a query for a target table and a data transfer object (DTO) used as an actual input/output buffer when data is input/output on a database. Since the type of copy book of the COBOL program and the type of table defined in the VSAM and the file management system are not always matched, when the table is defined in one form, serialization and deserialization processes are required in an input/output process with a program using another type of table. To this end, a module that takes charge of the serialization and the deserialization should be added, and the serialization and deserialization processes causes performance degradation.

### SUMMARY OF THE INVENTION

The present disclosure has been made in an effort to provide a method, a server, and a computer program stored in a computer readable storage medium which can automate creation of a table and DB I/O objects of a dataset by using information acquired through a static analysis without a serialization/deserialization process.

An exemplary embodiment of the present disclosure provides a method for creating a table and DB I/O objects in a relational database (RDB) migration process performed by a server. The method may include: generating metadata through a static analysis for a job control language (JCL) statement and an execution program (PGM), the metadata including job information, field information, and dataset information; identifying a plurality of layouts based on the dataset information; creating a first table corresponding to a first layout among the plurality of layouts; and creating a CRUD query corresponding to a second layout among the plurality of layouts based on the first table.

Alternatively, the identifying of the plurality of layouts based on the dataset information may include identifying a first data set group having the same dataset name and volume in the data set information, identifying a plurality of sub dataset groups having different field identifiers in the first dataset group, and identifying the layout of each of the plurality of first sub dataset groups.

Alternatively, the creating of the CRUD query corresponding to the second layout among the plurality of layouts based on the first table may include identifying a transform factor group including different factors between the first layout and the second layout, and creating a CRUD query of making the factor of the second layout included in the transform factor group correspond to the factor of the first layout included in the transform factor group.

Alternatively, the method may include creating a data access object (DAO) and a data transfer object (DTO) for each of the plurality of layouts.

Alternatively, the created data access object may be configured so that the created CRUD query is injected.

Alternatively, the method may include: identifying an actual table structure and a dataset structure which is referred by an execution program based on the metadata; creating a comparison result of the actual table structure and the dataset structure; and injecting a CRUD query corresponding to the comparison result onto the data transfer object.

Alternatively, the execution program may include COBOL.

Another exemplary embodiment of the present disclosure provides a server for providing a method for creating a table and DB I/O objects in RDB migration process. The server may include: a processor including one or more cores; and a memory, in which the processor may be configured to generate metadata through a static analysis for a job control language (JCL) statement and an execution program (PGM), the metadata including job information, field information, and dataset information, identify a plurality of layouts based on the dataset information, create a first table corresponding to a first layout among the plurality of layouts, and create a CRUD query corresponding to a second layout among the plurality of layouts based on the first table.

Yet another exemplary embodiment of the present disclosure provides a computer program stored in a computer-readable storage medium. When the computer program is executed by one or more processors, the computer program may execute a method for creating a table and DB I/O objects in RDB migration process, and the method may include creating metadata through a static analysis for a job control language (JCL) statement and an execution program (PGM), the metadata including job information, field information, and dataset information; identifying a plurality of layouts based on the dataset information; creating a first table corresponding to a first layout among the plurality of layouts; and creating a CRUD query corresponding to a second layout among the plurality of layouts based on the first table.

According to exemplary embodiments of the present disclosure, a method, a server, and a computer program stored in a computer readable storage medium can be provide, which can automate creation of a table and DB I/O objects of a dataset by using information acquired through a static analysis without a serialization/deserialization process.

### BRIEF DESCRIPTION OF THE DRAWINGS

Various aspects are now described with reference to the drawings and like reference numerals are generally used to designate like elements. In the following exemplary embodiments, for the purpose of description, multiple specific detailed matters are presented to provide general understanding of one or more aspects. However, it will be apparent that the aspect(s) can be executed without the specific detailed matters. In other examples, known structures and apparatuses are illustrated in a block diagram form in order to facilitate description of the one or more aspects.

FIG. 1 is a block diagram for describing an example of a server 100 according to some exemplary embodiments of the present disclosure.

FIG. 2 is a flowchart of a method for creating a table and DB I/O objects in a relational database (RDB) migration process of a dataset according to some exemplary embodiments of the present disclosure.

FIG. 3 is a diagram for describing metadata according to some exemplary embodiments of the present disclosure.

FIGS. 4A-4B are diagrams for describing an exemplary first layout and an exemplary second layout according to some exemplary embodiments of the present disclosure.

FIGS. 5A-5B are diagrams for describing an exemplary first table and an exemplary CRUD query according to some exemplary embodiments of the present disclosure.

FIG. 6 is a block diagram of a computer for creating a table and DB I/O objects in an RDB migration process according to some exemplary embodiments of the present disclosure.

FIG. 7 is a schematic block diagram of an exemplary computing environment according to an exemplary embodiment of the present disclosure.

### DETAILED DESCRIPTION

The aforementioned objects, features, and advantages of the present disclosure will be more apparent through the following embodiments associated with the accompanying drawings. Specific structural or functional descriptions described below are made only for the purposes of describing the exemplary embodiments according to the concept of the present disclosure and the exemplary embodiments according to the concept of the present disclosure may be carried out in various forms and should not be interpreted as being limited to the exemplary embodiments described in the present specification or application.

An exemplary embodiment according to a concept of the present disclosure may have various modifications and various forms and specific exemplary embodiments will be illustrated in the drawings and described in detail in the present specification or application. However, this does not limit the exemplary embodiments according to the concept of the present disclosure to specific disclosed forms, and it should be understood that the present disclosure covers all the modifications, equivalents and replacements included within the idea and technical scope of the present disclosure.

Terms including as first and/or second, and the like are used for describing various constituent elements, but the constituent elements are not limited by the terms. The terms may be used only for a purpose of distinguishing one component from other components and for example, a first component may be referred to as a second component, and similarly, the second component may be referred to even as the first component without departing from the scope of the present disclosure according to a concept of the present disclosure.

It should be understood that, when it is described that a component is “connected to” or “accesses” another component, the component may be directly connected to or access the other component or a third component may be present therebetween. In contrast, it should be understood that, when it is described that a component is “directly connected to” or “directly access” another element, no component is present between the component and another component. Meanwhile, other expressions describing the relationship of the components, that is, expressions such as “between” and “directly between” or “adjacent to” and “directly adjacent to” should be similarly interpreted.

Terms used in the present specification are used only to describe specific embodiments, and are not intended to limit the present disclosure. A singular form includes a plural form if there is no clearly opposite meaning in the context. In the present specification, it should be understood that term “include” or “have” indicates that a feature, a number, a step, an operation, a component, a part or the combination thereof which are implemented are present, but does not exclude a possibility of presence or addition of one or more other features, numbers, steps, operations, components, parts or combinations thereof, in advance.

If not contrarily defined, all terms used herein including technological or scientific terms have the same meanings as those generally understood by a person with ordinary skill in the art. Terms which are defined in a generally used dictionary should be interpreted to have the same meaning as the meaning in the context of the related art, and are not interpreted as an ideal meaning or excessively formal meanings unless clearly defined in the present specification.

FIG. 1 is a block diagram for describing an example of a server 100 according to some exemplary embodiments of the present disclosure.

Referring to FIG. 1, the server 100 in the present disclosure may include a processor 110, a storage unit 120, and a communication unit 130. However, components described above are not required in implementing the server 100 and the server 100 may thus have components more or less than components listed above.

The server 100 may include, for example, a predetermined type of computer system or computer device such as a microprocessor, a mainframe computer, a digital processor, a portable device, and a device controller.

The mainframe system, for example, as an industrial term referring to a large-sized computer manufactured in a large company such as IBM is primarily used in a computing business required for enterprise activities of very large companies such as large corporations or financial institutions and is configured by a centralization scheme rather than a distributed computing scheme.

The processor 110 may control an overall operation of the server 100. The processor 110 processes a signal, data, information, and the like input or output through the components of the server 100 or drives the application program stored in the memory to provide or process appropriate information or function.

The processor 110 may be constituted by one or more cores and may include processors for data analysis, which include a central processing unit (CPU), a general purpose graphics processing unit (GPGPU), a tensor processing unit (TPU), and the like of the server 100.

The storage unit 120 may include a memory and/or a persistent storage medium. The memory may include at least one type of storage medium of a flash memory type storage medium, a hard disk type storage medium, a multimedia card micro type storage medium, a card type memory (for example, an SD or XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk.

The storage unit 120 may store any type of information created or determined by the processor 110 or any type of information received by the communication unit 130. In the present disclosure, the storage unit 120 may store data input/output through the table and the DB I/O objects in the RDB migration process.

The communication unit 130 may include one or more modules which enable communication between the server 100 and the communication system and between the server 100 and a network. The communication unit 130 may include at least one of a wired Internet module, and a wireless Internet module.

Hereinafter, a method for creating a table and DB I/O objects in a relational database (RDB) migration process of a dataset according to some exemplary embodiments of the present disclosure will be described.

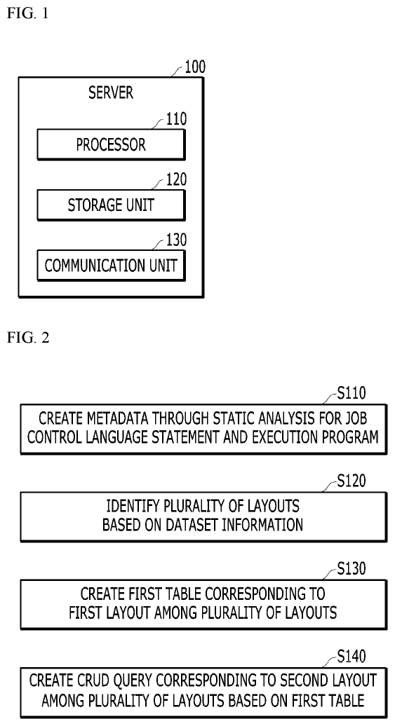

FIG. 2 is a flowchart of a method for creating a table and DB I/O objects in a relational database (RDB) migration process of a dataset according to some exemplary embodiments of the present disclosure.

A relational database (RDB) may be a database type that stores and provides an access related data points. The RDB may be based a relational model which is a method for expressing data in a table. In the RDB, each row of the table may be a record including a unique identifier (ID) called a key. A column of the table includes an attribute of the data, and each record generally has a value for each attribute, so a relationship between the data points may be set by using the value for each attribute. The RDB migration may mean all jobs which are generated within a process of sending and receiving data between different two databases. Upon data input/output between the DBs, a DB I/O object including a data access object (DAO) having a query for a target table and a data transfer object (DTO) used as an actual input/output buffer may be used.

Since the type of copy book of the COBOL program and the type of table defined in the VSAM and the file management system are not always matched, when the table is defined in one form, serialization and deserialization processes may be required in an input/output process with a program using another type of table. To this end, a module that takes charge of the serialization and the deserialization should be added on the system, and the serialization and deserialization processes cause performance degradation.

The method for creating a table and DB I/O objects in a relational database (RDB) migration process of a dataset according to some exemplary embodiments of the present disclosure may automate creation of the table and the DB I/O object of the dataset by using information acquired through a static analysis. Therefore, all record data need not be serialized, and since only an actual different part is processed by an SQL query, the performance of the server may be improved. Further, the method of the present disclosure may be more suitable for a DB I/O structure using a general DAO/DTO because the serialization/deserialization is not used.

According to some exemplary embodiments of the present disclosure, by referring to FIG. 2, the processor 110 of the server 100 may create metadata through a static analysis of a job control language (JCL) statement and an execution program (PGM).

Specifically, the processor 110 may acquire the JCL statement for the static analysis. A JCL may be a script language for indicating what is intended to be performed for an operating system in order to process data. The JCL may be constituted by a JCL statement having a series of rules. The JCL statement may indicate an operation (i.e., which program is executed, which resource the program requires, etc.) for the job with respect to the operating system.

The JCL statement may perform the following functions. The JCL statement may hand over the job to the operating system. Further, the JCL statement may present what should be performed to the operating system. The JCL statement may request allocate of a hardware device to a specific dataset to the operating system, and designate a program to be executed.

The JCL statement may include one or more job steps. Respective job steps may include an execution program (PGM), a dataset name (DSN), and a data description (DD). The execution program may include the COBOL program and a SORT program, but the scope of the present disclosure is not limited thereto.

The processor 110 may acquire the execution program corresponding to the execution program for the static analysis. For example, when the execution program is COBOL, the processor 110 may search for a COBOL program source corresponding to the execution program. The COBOL program source may be prestored in the database, etc.

The static analysis (or static program analysis) may mean analyzing computer software without an actual execution. In most cases, the static analysis is performed with respect to one type among versions of source codes. However, the static analysis may also be performed for a target file type. Contrary to this, a dynamic analysis (or a dynamic program analysis) may mean analyzing a program being executed.

The processor 110 may perform the static analysis for the JCL statement. For example, the processor 110 may acquire a JCL name, a data description (DD) name, a dataset name, and a volume name by analyzing the JCL statement. However, the present disclosure is not limited thereto, and the processor 110 may acquire various information through the static analysis for the JCL statement.

Further, the processor 110 may perform the static analysis for the execution program. For example, the processor 110 may acquire a program name, a file description (FD) name, an order of a field, a name, a type, a size, and key field information by analyzing the source code of the execution program. However, the present disclosure is not limited thereto, and the processor 110 may acquire various information through the static analysis for the execution program.

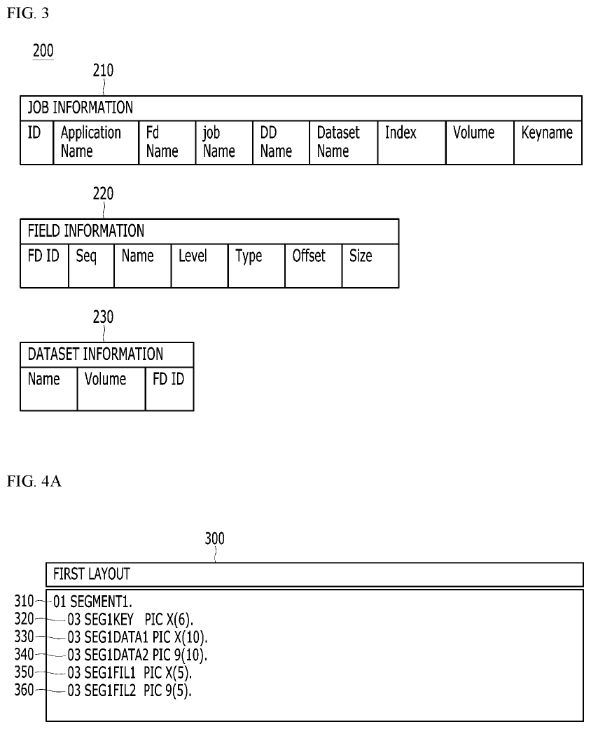

The processor 110 may create the metadata by using the information acquired through the static analysis for the JCL statement and the execution program. For example, the metadata may include job information, field information, and dataset information. A detailed exemplary embodiment of the information constituting the metadata is described with reference to FIG. 3.

The metadata may be used for creating the table and DB I/O objects of the dataset. For example, the metadata may be used for identifying the execution program to be executed through the job and the dataset to be used by the execution program. Further, the metadata may be used for identifying a layout of the dataset. Further, the metadata may be used for creating the table and DB I/O objects of the dataset.

According to some exemplary embodiments of the present disclosure, by referring to FIG. 2, the processor 110 of the server 100 may identify a plurality of layouts based on dataset information (s120).

As described above, the metadata may include the dataset information. The processor 110 may identify the plurality of layouts for one dataset by using the dataset information. For example, the dataset information included in the metadata may include a dataset name, a dataset volume, and a field identifier (FD ID). In this case, a specific step for identifying the plurality of layouts by using the dataset information is described below.

According to some exemplary embodiments of the present disclosure, the processor 110 of the server 100 may identify a first dataset group having a name and a volume of the same dataset in the dataset information, identify a plurality of first sub dataset groups having different field identifies (FD IDs) in the first dataset group, and identify the layout of each of the plurality of first sub dataset groups.

Specifically, the processor 110 may identify datasets having the same dataset name and dataset volume in the dataset information. The datasets having the same dataset name and dataset volume may be one identical dataset having only different layouts. The datasets having the same dataset name and dataset volume may be referred to as the first dataset group for convenience. The first dataset group may include one or more sub dataset groups. Here, one or more sub dataset groups may be classified according to the field identifier in the dataset information. For example, the first dataset group may be classified into a first sub dataset group constituted by a dataset(s) having a first field identifier and a second sub dataset group including a dataset(s) having a second field identifier. In this case, the processor 110 may identify that the first dataset group is constituted by two sub dataset groups. The respective sub dataset groups may be defined in different table structures according to respective field identifiers. Therefore, the processor 110 may identify a plurality of layouts as large as the number of different field identifiers in the first dataset group. For example, when three sub dataset groups are identified according to three different field identifiers, the processor 110 may identify three layouts in the first dataset group. However, the present disclosure is not limited thereto, and the processor 110 may identify the plurality of layouts through various methods.

According to some exemplary embodiments of the present disclosure, by referring to FIG. 2, the processor 110 of the server 100 may create a first table corresponding to a first layout among the plurality of layouts (s130), and create a CRUD query corresponding to a second layout among the plurality of layouts based on the first table.

As described above, without going through the serialization/deserialization process for the data, the processor 110 may create one table for one layout, and transform one table through the CRUD query with respect to the other layout. Here, the layout in which the table is created among the plurality of layouts may be referred to as the first layout for convenience. Further, the table corresponding to the first layout may be referred to as the first table for convenience.

First, the processor 110 may create one table (first table) with respect to one layout (first layout) among the plurality of identified layouts. A scheme of deciding the first layout or a scheme of creating the first table may be configured by various schemes according to a conventional JCL statement processing and execution program processing scheme.

When the processor 110 creates the first table with respect to the first layout, the processor 110 may create the CRUD query corresponding to the first table instead of creating tables with respect to all other layouts. Here, all layouts other than the first layout among the plurality of layouts may be referred to as the second layout.

The CRUD query may mean a query regarding four operations (create, read, update, and delete) primarily performed on the database. Since the plurality of layouts corresponds to one dataset, the processor 110 creates to perform I/O of data required for JCL statement processing and execution program processing without creating a separate table with respect to the second layout by creating the CRUD query based on the first table. A specific operation of creating the CRUD query corresponding to the second layout among the plurality of layouts based on the first table is described below.

According to some exemplary embodiments of the present disclosure, a step of creating the CRUD query corresponding to the second layout among the plurality of layouts based on the first table may include a step of identifying a transform factor group including different factors between the first layout and the second layout, and a step of creating the CRUD query of making the factor of the second layout included in the transform factor group correspond to the factor of the first layout included in the transform factor group.

Specifically, for example, the first layout may include ‘character string 1’ of 3 bits, ‘character string 2’ of 6 bits, and ‘character string 3’ of 6 bits, and the second layout may include ‘character string 4’ of 6 bits, ‘character string 5’ of 3 bits, and ‘character string 6’ of 6 bits. In this case, in the first layout and the second layout, the same factor may be ‘character string 3’ and ‘character string 6’. Further, in the first layout and the second layout, different factors may be ‘character string 1’ to ‘character string 2’ and ‘character string 4’ to ‘character string 5’. Here, different factors may be referred to as the transform factor group in which the CRUD query is created for transform (or mapping).

When the transform factor group is decided, the processor 110 may create a CRUD query for making the factors of the second layout correspond to the factors of the first layout (or first table). For example, the processor 110 may create a query of extracting first 3 bits of ‘character string 4’ to correspond to ‘character string 1’. In addition, the processor 110 may create a query of combining last 3 bits of ‘character string 4’ and 3 bits of ‘character string 5’ to correspond to ‘character string 2’. Since ‘character string 3’ is the same factor as ‘character string 6’, ‘character string 3’ is not the transform factor group, and therefore, the processor 110 does not create the CRUD query for corresponding to ‘character string 3’. The created CRUD query may be injected on the data access object and the data transfer object. Therefore, the CRUD query is created based on the first table without creating the separate table for the second layout, and as a result, the serialization and deserialization are not requested in the I/O process of the data.

According to some exemplary embodiments of the present disclosure, the processor 110 of the server 100 may create the data access object (DAO) and the data transfer object (DTO) for each of the plurality of layouts. In this case, the created data access object may be configured so that the CRUD query is injected.

The processor 110 may create a DB I/O object for inputting/outputting data on the database. The DB I/O object may include a DB I/O object including a data access object (DAO) having a query for a target table and a data transfer object (DTO) used as an actual input/output buffer. The data access object created according to some exemplary embodiments of the present disclosure may have a component that may inject the CRUD query corresponding to the second layout based on the first table unlike the related art. Therefore, the method for creating the table and DB I/O objects according to the present disclosure may perform data I/O by using one table without creating the tables with respect to all layouts. Therefore, since serialization and deserialization of data required for using different tables are not requested, the performance may be improved.

According to some exemplary embodiments of the present disclosure, the processor 110 may identify an actual table structure and a dataset structure referred by the execution program based on the metadata. In addition, the processor 110 may create a comparison result between the actual table structure and the dataset structure. In addition, the processor 110 may inject the CRUD query corresponding to the comparison result onto the data transfer object.

When the first table for the first layout and the CRUD query corresponding to the second layout are created, the processor 110 may perform the data I/O by using the first table and the CRUD query created to process the JCL statement and execution program. The processor 110 may identify the program to be executed by the requested job and the dataset to be used by the program by using the metadata.

Specifically, the processor 110 may identify the actual table structure by using the metadata. For example, the processor 110 may identify the actual table structure through a ‘join’ query under the condition that the field identifier of the dataset information and the field identifier of the field information are identical (the FD ID of the dataset information=the FD ID of the field information). Specifically, the processor 110 may identify the dataset structure to be referred by the execution program by using the metadata. For example, the processor 110 may identify the dataset structure by a condition that the identifier of the job information and the field identifier of the field information are identical (the ID of the job information=the FD ID of the field information). In addition, the processor 110 compares the actual table structure and the dataset structure to create a comparison result for identifying a difference.

When the comparison result is created between the actual table structure and the dataset structure, the processor 110 may inject the CRUD query corresponding to the dataset structure on the data access object for data I/O in the process of processing the execution program. In this case, the processor 110 may perform the data I/O by using the data access object into which an appropriate CRUD query is injected.

As described above, the method for creating the table and DB I/O objects according to the present disclosure may use a scheme of transforming one table by using the CRUD query without creating the tables with respect to all layouts. Therefore, since the serialization/deserialization for the data is not performed, the performance may be enhanced. Further, since the query used for transforming the table is the query used in the database, additional logic is not required on the system, and a multi-structure dataset may be supported through general mapping to the data access object/data transfer object.

FIG. 3 is a diagram for describing metadata according to some exemplary embodiments of the present disclosure.

As described above, the processor 110 may create metadata 200 by using the information acquired through the static analysis for the JCL statement and the execution program.

Specifically, for example, the processor 110 may acquire a JCL name, a data description (DD) name, a dataset name, and a volume name by analyzing the JCL statement. For example, the processor 110 may acquire a program name, a file description (FD) name, an order of a field, a name, a type, a size, and key field information by statically analyzing the source code of the execution program.

The metadata may create job information 210, field information 220, and dataset information 230 by using the information acquired through the static analysis. For example, the job information 210 may include ‘ID’, ‘Application Name’, ‘job Name’, ‘DD Name’, ‘Dataset Name’, ‘Index’, ‘Volume’, and ‘Keyname’. Further, the field information 220 may include ‘FD ID’, ‘Seq’, ‘Name’, ‘Level’, ‘Type’, ‘Offset’, and ‘Size’. Further, the dataset information 230 may include ‘Name’, ‘Volume’, and ‘FD ID’.

As described above, the metadata may be used for creating the table and DB I/O objects of the dataset. For example, the metadata may be used for identifying the execution program to be executed through the job and the dataset to be used by the execution program. Further, the metadata may be used for identifying a layout of the dataset. Further, the metadata may be used for creating the table and DB I/O objects of the dataset.

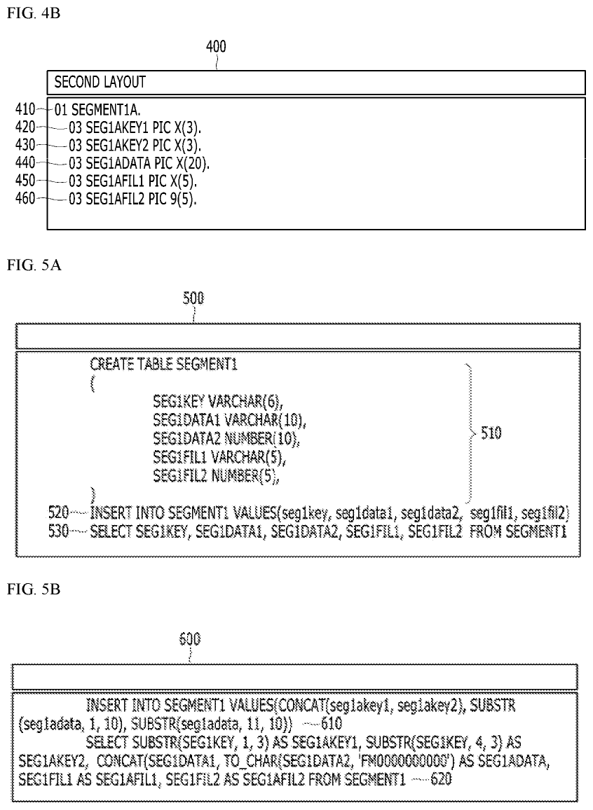

FIG. 4A-4B are diagrams for describing an exemplary first layout and an exemplary second layout according to some exemplary embodiments of the present disclosure. FIGS. 5A-5B are diagrams for describing an exemplary first table and an exemplary CRUD query according to some exemplary embodiments of the present disclosure.

A first layout 300 and a second layout 400 may be a dataset group having the same dataset name and dataset volume. As described above, when the datasets have the same dataset name and dataset volume, the datasets may be the same dataset with only different layouts. The datasets may be referred to as the first dataset group for convenience.

As illustrated in FIGS. 4A-4B, since the FD ID of the first layout 300 is ‘SEGMENT1’ and the FD ID of the second layout 400 is ‘SEGMENT1A’, both field identifiers may be different from each other. Therefore, the first dataset group may include the dataset having the first layout as one sub dataset group, and include the dataset having the second layout as different sub dataset groups. As described above, since the number of plurality of sub dataset groups having different field identifiers in the first dataset group is 2, the processor 110 may identify that the first dataset group has two different layouts. In this case, the processor 110 may create the first table for the first layout. In addition, the processor 110 may create the CRUD query corresponding to the second layout based on the first table. In FIG. 4B, one second layout is illustrated, but the number of second layouts may be diversified according to the type (distinguished according to the field identifier) of dataset.

FIG. 5A illustrates an exemplary statement 500 of defining the first table corresponding to the first layout 300 disclosed in FIG. 4 and inputting a record onto the first table. As illustrated in FIG. 5A, a statement 510 of defining the first table may define the first table according to the factor included in the first layout 300. After the first table is defined, the record may be added onto the first table through the statements ‘insert’ and ‘select’.

FIG. 5B illustrates the CRUD query corresponding to the second layout 400.

When the first layout 300 and the second layout 400 are compared with each other, a fourth factor 350 and a fifth factor 360 among the factors of the first layout 300 are the same as a fourth factor 450 and a fifth factor 460 among the factors of the second layout 400. Contrary to this, a first factor 320, a second factor 330, and a third factor 340 among the factors of the first layout are different from a first factor 420, a second factor 430, and a third factor 440 among the factors of the second layout. In this case, the processor 110 may identify the first factor 320, the second factor 330, and the third factor 340, and the first factor 420, the second factor 430, and the third factor 440 among the factors of the second layout as the transform factor group.

When the transform factor group is identified, the processor 110 may create a CRUD query of manipulating the factor of the second layout included in the transform factor group to correspond to the factor of the first layout 300 included in the transform factor group.

For example, the processor 110 may create ‘CONCAT(seg1akey1, seg1akey)’ to make the first factor 420 and the second factor 430 of the second layout correspond to the first factor 320 of the first layout.

Further, the processor 110 may create SUBSTR(seg1akey1, 1, 10)′ to make a part of the third factor 420 of the second layout correspond to the second factor 330 of the first layout.

Further, the processor 110 may create SUBSTR(seg1akey1, 11, 10)′ to make a part of the third factor 420 of the second layout correspond to the third factor 340 of the first layout.

In addition, the record may be added onto the transformed table through the statements ‘insert’ and ‘select’. The CRUD query for the factor included in the transform factor group is not created. The created CRUD query may be injected into the data access object and used for the data I/O in the JCL statement and execution program processing process.

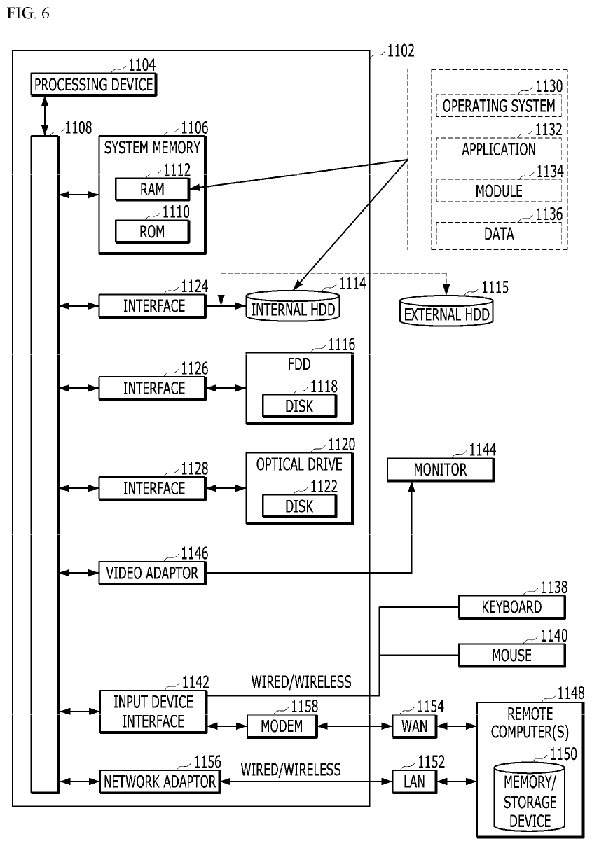

FIG. 6 is a block diagram of a computer for creating a table and DB I/O objects in a relational database (RDB) migration process of the dataset according to some exemplary embodiments of the present disclosure.

The present disclosure has been described as being generally implementable by the computing device, but those skilled in the art will appreciate well that the present disclosure is combined with computer executable commands and/or other program modules executable in one or more computers and/or be implemented by a combination of hardware and software.

In general, a program module includes a routine, a program, a component, a data structure, and the like performing a specific task or implementing a specific abstract data form. Further, those skilled in the art will well appreciate that the method of the present disclosure may be carried out by a personal computer, a hand-held computing device, a microprocessor-based or programmable home appliance (each of which may be connected with one or more relevant devices and be operated), and other computer system configurations, as well as a single-processor or multiprocessor computer system, a mini computer, and a main frame computer.

The exemplary embodiments of the present disclosure may be carried out in a distribution computing environment, in which certain tasks are performed by remote processing devices connected through a communication network. In the distribution computing environment, a program module may be located in both a local memory storage device and a remote memory storage device.

The computer generally includes various computer readable media. The computer accessible medium may be any type of computer readable medium, and the computer readable medium includes volatile and non-volatile media, transitory and non-transitory media, and portable and non-portable media. As a non-limited example, the computer readable medium may include a computer readable storage medium and a computer readable transmission medium. The computer readable storage medium includes volatile and non-volatile media, transitory and non-transitory media, and portable and non-portable media constructed by a predetermined method or technology, which stores information, such as a computer readable command, a data structure, a program module, or other data. The computer readable storage medium includes a RAM, a Read Only Memory (ROM), an Electrically Erasable and Programmable ROM (EEPROM), a flash memory, or other memory technologies, a Compact Disc (CD)-ROM, a Digital Video Disk (DVD), or other optical disk storage devices, a magnetic cassette, a magnetic tape, a magnetic disk storage device, or other magnetic storage device, or other predetermined media, which are accessible by a computer and are used for storing desired information, but is not limited thereto.

The computer readable transport medium generally implements a computer readable command, a data structure, a program module, or other data in a modulated data signal, such as a carrier wave or other transport mechanisms, and includes all of the information transport media. The modulated data signal means a signal, of which one or more of the characteristics are set or changed so as to encode information within the signal. As a non-limited example, the computer readable transport medium includes a wired medium, such as a wired network or a direct-wired connection, and a wireless medium, such as sound, Radio Frequency (RF), infrared rays, and other wireless media. A combination of the predetermined media among the foregoing media is also included in a range of the computer readable transport medium.

An illustrative environment 1100 including a computer 1102 and implementing several aspects of the present disclosure is illustrated, and the computer 1102 includes a processing device 1104, a system memory 1106, and a system bus 1108. The system bus 1108 connects system components including the system memory 1106 (not limited) to the processing device 1104. The processing device 1104 may be a predetermined processor among various commonly used processors. A dual processor and other multi-processor architectures may also be used as the processing device 1104.

The system bus 1108 may be a predetermined one among several types of bus structure, which may be additionally connectable to a local bus using a predetermined one among a memory bus, a peripheral device bus, and various common bus architectures. The system memory 1106 includes a ROM 1110, and a RAM 1112. A basic input/output system (BIOS) is stored in a non-volatile memory 1110, such as a ROM, an EPROM, and an EEPROM, and the BIOS includes a basic routing helping a transport of information among the constituent elements within the computer 1102 at a time, such as starting. The RAM 1112 may also include a high-rate RAM, such as a static RAM, for caching data.

The computer 1102 also includes an embedded hard disk drive (HDD) 1114 (for example, enhanced integrated drive electronics (EIDE) and serial advanced technology attachment (SATA))— the embedded HDD 1114 being configured for exterior mounted usage within a proper chassis (not illustrated)—a magnetic floppy disk drive (FDD) 1116 (for example, which is for reading data from a portable diskette 1118 or recording data in the portable diskette 1118), and an optical disk drive 1120 (for example, which is for reading a CD-ROM disk 1122, or reading data from other high-capacity optical media, such as a DVD, or recording data in the high-capacity optical media). A hard disk drive 1114, a magnetic disk drive 1116, and an optical disk drive 1120 may be connected to a system bus 1108 by a hard disk drive interface 1124, a magnetic disk drive interface 1126, and an optical drive interface 1128, respectively. An interface 1124 for implementing an exterior mounted drive includes, for example, at least one of or both a universal serial bus (USB) and the Institute of Electrical and Electronics Engineers (IEEE) 1394 interface technology.

The drives and the computer readable media associated with the drives provide non-volatile storage of data, data structures, computer executable commands, and the like. In the case of the computer 1102, the drive and the medium correspond to the storage of random data in an appropriate digital form. In the description of the computer readable media, the HDD, the portable magnetic disk, and the portable optical media, such as a CD, or a DVD, are mentioned, but those skilled in the art will well appreciate that other types of computer readable media, such as a zip drive, a magnetic cassette, a flash memory card, and a cartridge, may also be used in the illustrative operation environment, and the predetermined medium may include computer executable commands for performing the methods of the present disclosure.

A plurality of program modules including an operation system 1130, one or more application programs 1132, other program modules 1134, and program data 1136 may be stored in the drive and the RAM 1112. An entirety or a part of the operation system, the application, the module, and/or data may also be cached in the RAM 1112. It will be well appreciated that the present disclosure may be implemented by several commercially usable operation systems or a combination of operation systems.

A user may input a command and information to the computer 1102 through one or more wired/wireless input devices, for example, a keyboard 1138 and a pointing device, such as a mouse 1140. Other input devices (not illustrated) may be a microphone, an IR remote controller, a joystick, a game pad, a stylus pen, a touch screen, and the like. The foregoing and other input devices are frequently connected to the processing device 1104 through an input device interface 1142 connected to the system bus 1108, but may be connected by other interfaces, such as a parallel port, an IEEE 1394 serial port, a game port, a USB port, an IR interface, and other interfaces.

A monitor 1144 or other types of display devices are also connected to the system bus 1108 through an interface, such as a video adaptor 1146. In addition to the monitor 1144, the computer generally includes other peripheral output devices (not illustrated), such as a speaker and a printer.

The computer 1102 may be operated in a networked environment by using a logical connection to one or more remote computers, such as remote computer(s) 1148, through wired and/or wireless communication. The remote computer(s) 1148 may be a work station, a computing device computer, a router, a personal computer, a portable computer, a microprocessor-based entertainment device, a peer device, and other general network nodes, and generally includes some or an entirety of the constituent elements described for the computer 1102, but only a memory storage device 1150 is illustrated for simplicity. The illustrated logical connection includes a wired/wireless connection to a local area network (LAN) 1152 and/or a larger network, for example, a wide area network (WAN) 1154. The LAN and WAN networking environments are general in an office and a company, and make an enterprise-wide computer network, such as an Intranet, easy, and all of the LAN and WAN networking environments may be connected to a worldwide computer network, for example, the Internet.

When the computer 1102 is used in the LAN networking environment, the computer 1102 is connected to the local network 1152 through a wired and/or wireless communication network interface or an adaptor 1156. The adaptor 1156 may make wired or wireless communication to the LAN 1152 easy, and the LAN 1152 also includes a wireless access point installed therein for the communication with the wireless adaptor 1156. When the computer 1102 is used in the WAN networking environment, the computer 1102 may include a modem 1158, is connected to a communication computing device on a WAN 1154, or includes other means setting communication through the WAN 1154 via the Internet. The modem 1158, which may be an embedded or outer-mounted and wired or wireless device, is connected to the system bus 1108 through a serial port interface 1142. In the networked environment, the program modules described for the computer 1102 or some of the program modules may be stored in a remote memory/storage device 1150. The illustrated network connection is illustrative, and those skilled in the art will appreciate well that other means setting a communication link between the computers may be used.

The computer 1102 performs an operation of communicating with a predetermined wireless device or entity, for example, a printer, a scanner, a desktop and/or portable computer, a portable data assistant (PDA), a communication satellite, predetermined equipment or place related to a wirelessly detectable tag, and a telephone, which is disposed by wireless communication and is operated. The operation includes a wireless fidelity (Wi-Fi) and Bluetooth wireless technology at least. Accordingly, the communication may have a pre-defined structure, such as a network in the related art, or may be simply ad hoc communication between at least two devices.

The Wi-Fi enables a connection to the Internet and the like even without a wire. The Wi-Fi is a wireless technology, such as a cellular phone, which enables the device, for example, the computer, to transmit and receive data indoors and outdoors, that is, in any place within a communication range of a base station. A Wi-Fi network uses a wireless technology, which is called IEEE 802.11 (a, b, g, etc.) for providing a safe, reliable, and high-rate wireless connection. The Wi-Fi may be used for connecting the computer to the computer, the Internet, and the wired network (IEEE 802.3 or Ethernet is used). The Wi-Fi network may be operated at, for example, a data rate of 11 Mbps (802.11a) or 54 Mbps (802.11b) in an unauthorized 2.4 and 5 GHz wireless band, or may be operated in a product including both bands (dual bands).

Those skilled in the art may appreciate that information and signals may be expressed by using predetermined various different technologies and techniques. For example, data, indications, commands, information, signals, bits, symbols, and chips referable in the foregoing description may be expressed with voltages, currents, electromagnetic waves, magnetic fields or particles, optical fields or particles, or a predetermined combination thereof.

Those skilled in the art will appreciate that the various illustrative logical blocks, modules, processors, means, circuits, and algorithm operations described in relationship to the exemplary embodiments disclosed herein may be implemented by electronic hardware (for convenience, called “software” herein), various forms of program or design code, or a combination thereof. In order to clearly describe compatibility of the hardware and the software, various illustrative components, blocks, modules, circuits, and operations are generally illustrated above in relation to the functions of the hardware and the software. Whether the function is implemented as hardware or software depends on design limits given to a specific application or an entire system. Those skilled in the art may perform the function described by various schemes for each specific application, but it shall not be construed that the determinations of the performance depart from the scope of the present disclosure.

Various exemplary embodiments presented herein may be implemented by a method, a device, or a manufactured article using a standard programming and/or engineering technology. A term “manufactured article” includes a computer program, a carrier, or a medium accessible from a predetermined computer-readable storage device. For example, the computer-readable storage medium includes a magnetic storage device (for example, a hard disk, a floppy disk, and a magnetic strip), an optical disk (for example, a CD and a DVD), a smart card, and a flash memory device (for example, an EEPROM, a card, a stick, and a key drive), but is not limited thereto. Further, various storage media presented herein include one or more devices and/or other machine-readable media for storing information.

It shall be understood that a specific order or a hierarchical structure of the operations included in the presented processes is an example of illustrative accesses. It shall be understood that a specific order or a hierarchical structure of the operations included in the processes may be rearranged within the scope of the present disclosure based on design priorities. The accompanying method claims provide various operations of elements in a sample order, but it does not mean that the claims are limited to the presented specific order or hierarchical structure.

The description of the presented exemplary embodiments is provided so as for those skilled in the art to use or carry out the present disclosure. Various modifications of the exemplary embodiments may be apparent to those skilled in the art, and general principles defined herein may be applied to other exemplary embodiments without departing from the scope of the present disclosure. Accordingly, the present disclosure is not limited to the exemplary embodiments suggested herein, and shall be interpreted within the broadest meaning range consistent to the principles and new characteristics presented herein.

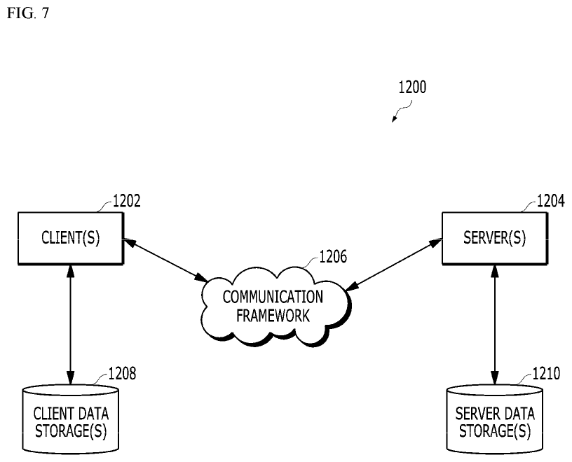

FIG. 7 is a schematic block diagram of an exemplary computing environment according to an exemplary embodiment of the present disclosure.

Referring to FIG. 7, a system 1200 includes one or more clients 1202. The client(s) 1202 may be hardware and/or software (e.g., a thread, a process, and a computing device). The client(s) 1202 may keep a cookie(s) and/or association situation information by using the present disclosure, for example.

The system 1200 also includes one or more server(s) 1204. The server(s) 1204 may also be hardware and/or software (e.g., the thread, the process, and the computing device). The server 1204 may keep a thread that performs transform by using the present disclosure, for example. One available communication between the client 1202 and the server 1204 may be a form of a data packet configured to be transmitted between two or more computer processes. The data packet may include, for example, the cookie and/or associated situation information. The system 1200 includes a communication framework 1206 (e.g., a global communication network such as the Internet) which may be used to facilitate the communication between the client(s) 1202 and the server(s) 1204.

The communication may be facilitated through wired (including an optical fiber) and/or wireless technology. The client(s) 1202 operate(s) in connection to one or more client data storage(s) 1208 which may be used for storing information (e.g., the cookie(s) and/or associated situation information) which is local to the client(s) 1202. Similarly, the server(s) 1204 operate(s) in connection to one or more server data storage(s) 1210 which may be used for storing the information which is local to the servers 1204.

The present disclosure has been described with reference to the preferred embodiments. However, it will be appreciated by those skilled in the art that various modifications and changes of the present disclosure can be made without departing from the spirit and the scope of the present disclosure which are defined in the appended claims.

What is claimed is:

1. A method for creating a table and DB I/O objects in a relational database (RDB) migration process performed by a server, the method comprising:
creating metadata through a static analysis for a job control language (JCL) statement and an execution program (PGM), the metadata including job information, field information, and dataset information;
identifying a plurality of layouts based on the dataset information;
creating a first table corresponding to a first layout among the plurality of layouts; and
creating a CRUD query corresponding to a second layout among the plurality of layouts based on the first table.

2. The method of claim 1, wherein the identifying of the plurality of layouts based on the dataset information includes
identifying a first data set group having the same dataset name and volume in the data set information,
identifying a plurality of sub dataset groups having different field identifiers in the first dataset group, and
identifying the layout of each of the plurality of first sub dataset groups.

3. The method of claim 1, wherein the creating of the CRUD query corresponding to the second layout among the plurality of layouts based on the first table includes
identifying a transform factor group including different factors between the first layout and the second layout, and
creating a CRUD query of making the factor of the second layout included in the transform factor group correspond to the factor of the first layout included in the transform factor group.

4. The method of claim 1, comprising:
creating a data access object (DAO) and a data transfer object (DTO) for each of the plurality of layouts.

5. The method of claim 1, wherein the created data access object is configured so that the created CRUD query is injected.

6. The method of claim 4, comprising:
identifying an actual table structure and a dataset structure which is referred by an execution program based on the metadata;
creating a comparison result of the actual table structure and the dataset structure; and
injecting a CRUD query corresponding to the comparison result onto the data transfer object.

7. The method of claim 1, wherein the execution program includes COBOL.

8. A server for providing a method for creating a table and DB I/O objects in RDB migration process, the server comprising:
a processor including one or more cores; and
a memory,
wherein the processor is configured to
create metadata through a static analysis for a job control language (JCL) statement and an execution program (PGM), the metadata including job information, field information, and dataset information,
identify a plurality of layouts based on the dataset information,
create a first table corresponding to a first layout among the plurality of layouts, and
create a CRUD query corresponding to a second layout among the plurality of layouts based on the first table.

9. A computer program stored in a computer-readable storage medium, wherein when the computer program is executed by one or more processors, the computer program executes a method for creating a table and DB I/O objects in RDB migration process, and the method comprises:
creating metadata through a static analysis for a job control language (JCL) statement and an execution program (PGM), the metadata including job information, field information, and dataset information;
identifying a plurality of layouts based on the dataset information;
creating a first table corresponding to a first layout among the plurality of layouts; and
creating a CRUD query corresponding to a second layout among the plurality of layouts based on the first table.
